(19) United States
(12) Patent Application Publication
(10) Pub. No.: US 2021/0379871 A1
(43) Pub. Date: Dec. 9, 2021

(54) TRANSPARENT, SHATTERPROOF, BULLET-RESISTANT GLAZING WITH FIRE PROTECTION PROPERTIES

(71) Applicant: SAINT-GOBAIN GLASS FRANCE, Courbevoie (FR)

(72) Inventors: Ulrich HERMENS, Aachen (DE); Rolf KOCHS, Aachen (DE); Marcus NEANDER, Eschweiler (DE); Olaf KOWALKE, Düren-Arnoldsweiler (DE)

(21) Appl. No.: 16/322,752

(22) PCT Filed: Jun. 9, 2017
(86) PCT No.: PCT/EP2017/064110

§ 371 Date: Feb. 1, 2019

(30) Foreign Application Priority Data
Aug. 3, 2016 (EP) 16182552.6

(51) Int. Cl. B32B 17/10; F41H 5/04; A62C 2/06; B32B 7/12; B32B 27/30; B32B 27/40; B32B 37/12; B32B 37/18

(52) U.S. Cl. CPC B32B 17/10055; B32B 2571/02; A62C 2/06; B32B 7/12; B32B 17/10311; B32B 17/10761; B32B 17/1077; B32B 17/10788; B32B 17/10935; B32B 27/30; B32B 27/40; B32B 27/306; B32B 37/12; B32B 37/182; B32B 2307/412; B32B 2307/558; B32B 2307/71; B32B 2419/00; B32B 2329/06; B32B 2375/00; B32B 2331/04; B32B 2315/08; B32B 2307/3065; F41H 5/0407

(57) ABSTRACT

A transparent, shatterproof, bullet-resistant glazing with fire protection properties, consisting of a ballistic block constructed from at least two transparent panes adherently bonded to one another by at least one transparent, adhesion-promoting layer, wherein each pane has a thickness of at least 3 mm, a fire protection unit constructed from at least two transparent panes adherently bonded by a transparent, intumescent layer, and at least one spacer between the fire protection unit and the ballistic block, the surfaces of the unit and the block being arranged parallel or substantially parallel to one another such that a hollow space is situated therebetween.

### FIELD OF THE INVENTION

The present invention relates to a transparent, shatterproof, bullet-resistant glazing with fire protection properties, a method for production thereof, and use thereof.

### PRIOR ART

Conventional window glasses are unsuitable as fire protection barriers because they burst with every relatively strong thermal load. The fire and the resulting heat radiation can spread unchecked. The reason for this resides in their relatively high coefficient of thermal expansion and their relatively low tensile strength. Consequently, in order to prevent the bursting of glass panes from fire for a longer time, wire meshes that hold the structure together even after glass breakage are even introduced into 6-to-8-mm-thick panes. However, due to the reduced light permeability, their use is limited to partitions, doors, and skylights. By now, a number of wire-free fire protection glasses that are also suitable for window construction have been developed.

The term “fire protection glazings” is generally understood to mean components that are made of one or a plurality of light-permeable systems that are mounted in a frame with holders and seals. In terms of their fire resistance classes, a distinction is made between EI and E glazings. Such glazings are additionally characterized by the indication of the duration of their fire resistance in minutes (e.g.: EI 30, EI 90, E 30, EI 120). E glazings prevent only the spread of fire and smoke for the corresponding time. EI glazings must additionally prevent the passage of heat radiation.

Currently common as EI glazings are combined systems of fire protection panes and fill layers between the panes. In this multipane glazing, the fill layers foam in the event of fire and thus act as a heat shield. The foaming is also referred to as intumescence. These fill layers can be either organic or inorganic or a combination of the two. Their task is to delay the transfer of heat, on the one hand, by endothermic processes, such as vaporization in the fill layers; on the other, by an insulating residue, such as foam, which should adhere well to the glass.

Although these fire protection glazings can solve the problem of the spread of fire, they have no bullet-resistant properties.

Known from German patent application DE 10 2010 037 966 A1 is a monolithic, attack resistant, and fire-resistant glazing. This glazing has at least one intumescent fire protection layer, wherein at least one plastic layer is arranged in each case directly or indirectly on the opposite side surfaces of the fire protection glazing. At least one glass or glass ceramic pane is arranged in each case on the sides of the plastic layer facing away from the fire protection glazing. When the plastic content in front of or behind the fire protection glass reaches a certain mass, it does, in fact, positively affect burglary resistance but negatively affects fire behavior. Moreover, this glazing has only little or no bullet-resistant effect and offers no splinter protection.

Monolithic bullet-resistant glazings or bulletproof glasses based on composite safety glasses are likewise known. Reference is made by way of example to the European patent application EP 2 434 249 A1, the European patent EP 1 004 433 B1, the German utility model DE 20 2011 001 371 U1, or the German patent applications DE 44 15 879 A1, DE 41 42 416 A1, DE 100 48 566 A1, and DE 197 45 248 A1. These bullet-resistant glazings offer no security against splinters and they have no fire protection effect.

With regard to protection against splinters, the bullet-resistant insulating glass element known from the European patent application EP 0 528 354 A1 brings a certain improvement. In this insulating glass element, a single pane is arranged as insulation behind the monolithic ballistic block, i.e., on the side facing away from the attack side, which pane can catch outgoing splinters, so long as the impact is not too violent. However, this known insulating glass element as well as well has no fire protection effect.

In order to achieve a bullet-resistant effect and a fire protection effect in a glazing, monolithic glazings have been developed in which a fire protection glazing is laminated directly onto a ballistic block. However, the fire protection glazing makes no direct contribution to bullet-resistance and protection against splinters. In addition, the production of these monolithic glazings is complicated and associated with very high reject rates. The attempt has also been made to arrange the fire protection glazing in front, i.e., on the impact side, as insulating glass; however, the same disadvantages are encountered.

EP 2 110 238 A1 discloses a blast-effect-limiting glazing, whose object is to reduce the pressure of an explosion. Blast resistance makes demands on the glazing that are different from bullet-resistance. The glazing consists of three composite glasses that are bonded to one another via spacers such that a hollow space is formed between each two adjacent composite glasses. For protection against fires that can develop as a result of the explosion, it is proposed to implement one of the composite glasses as fire-resistant glass with intumescent layers.

BE 1013332 A3 discloses a fire protection unit as part of an insulating glazing. However, the insulating glazing has no bullet-resistant properties.

GB 1451933 A and EP 0524418 A1 disclose insulating glazings made of two fire protection units that are bonded to one another via a spacer. They also have no bullet-resistant properties.

The object of the present invention was to propose a transparent, shatterproof, bullet-resistant glazing with fire protection properties that no longer has the disadvantages of the prior art. In particular, the novel glazing should be producible in a simple manner and with only very low reject rates—if at all. Moreover, in addition to bullet-resistance and fire protection, the novel glazing should also provide protection against splinters.

These and other objects are accomplished according to the proposal of the invention by the transparent, shatterproof, bullet-resistant glazing with fire protection properties and the method for its production with the features of the independent claims. Advantageous embodiments of the invention are indicated by the features of the dependent claims.

### DETAILED DESCRIPTION OF THE INVENTION

The invention relates to a transparent, bullet-resistant glazing with fire protection properties. The essence of the invention resides in the combination of a ballistic block with a fire protection glazing (fire protection unit) that is arranged behind the ballistic block, i.e., on the side facing away from the impact, with a hollow space situated between the ballistic block and the fire protection glazing, in which the outgoing splinters are caught by the fire protection glazing.

The term “fire protection glazings” is generally understood to mean components that are made of one or a plurality of light-permeable systems that are mounted in a frame with holders and seals. In terms of their fire resistance classes, a distinction is made between EI and E glazings. Such glazings are additionally characterized by the indication of the duration of their fire resistance in minutes (e.g.: EI 30, EI 90, E 30, EI 120). E glazings prevent only the spread of fire and smoke for the corresponding time. EI glazings must additionally prevent the passage of heat radiation.

The transparent glazing according to the invention preferably has transmittance in the visible spectral range of at least 20%, particularly preferably at least 50%. A transparent glazing or a transparent component of a glazing can have transmittance in the visible spectral range >70%.

With bullet-resistant glazings, a distinction is typically made between an attack side or attack direction and a protected side or protection direction. The attack side of the glazing faces the direction (attack direction) from which a possible bombardment is expected, typically the external environment of the building or space separated by the glazing. The protected side faces the direction (protection direction) that is intended to be protected against bombardment, typically the interior of the building or space separated by the glazing.

The glazing according to the invention comprises a ballistic block and a fire protection unit that are bonded to one another via a spacer in the manner of an insulating glazing via a spacer such that a hollow space is formed therebetween. Advantageously, the glazing consists only of the ballistic block and the fire protection unit bonded thereto via the spacer. The space requirement, complexity, and costs of the glazing are then advantageously low, while the required bullet-resistance effects and fire protection properties are nevertheless satisfied. At the site of use, the ballistic block of the glazing according to the invention faces the attack side/attack direction, whereas the fire protection unit faces the protected side/protection direction.

The fire protection glazing or the transparent fire protection unit of the transparent, shatterproof, bullet-resistant glazing comprises at least two panes, preferably glass panes, adherently bonded by means of at least one transparent, intumescent layer. The fire protection unit is preferably constructed only of glass panes and intumescent layers therebetween. In a particularly preferred embodiment, the fire protection unit is constructed from at least three panes, in particular exactly three panes with intumescent layers positioned therebetween.

The transparent, intumescent layers are made of alkali silicates and/or of salt-filled aqueous acrylic polymers. Preferably, alkali silicates are used, in particular sodium silicate.

Examples of suitable transparent, intumescent layers are found in international patent application WO 2007/11887 A1.

The thickness of the intumescent layers is preferably from 2 mm to 8 mm, particularly preferably from 3 mm to 6 mm.

The fire protection units can be stabilized against UV radiation. Examples of suitable stabilizers are known from German patent application DE 10 2005 006 748 A1 and European patent application EP 1 398 147 A1.

The transparent, shatterproof, bullet-resistant glazing also includes at least one, in particular one, ballistic block. The term “ballistic block” refers to a glass laminate with bullet-resistant properties, in particular a glazing unit in accordance with Euro Standard EN 1063. The ballistic block is constructed from at least two, preferably from two to eight transparent panes, in particular glass panes, that are adherently bonded to one another by a transparent adhesion-promoting layer. The classification and requirements for the testing of ballistic blocks are regulated by the Euro Standard EN 1063 for the glass and EN 1522 for the window system. In advantageous embodiments, the ballistic block is constructed from at least three and in particular at least four panes with adhesion-promoting layers positioned therebetween. The ballistic block advantageously contains no other structure-forming components other than the panes and the adhesion-promoting layers positioned therebetween, but it can have, for example, coatings on the panes or splinter-binding films.

Preferably, the panes of the fire protection unit as well as those of the ballistic block are constructed from at least one glass, selected from the group consisting of flat glass, float glass, quartz glass, borosilicate glass, soda lime glass, and ceramic glass. The glass panes are particularly preferably constructed from soda lime glass.

The thickness of the glass panes of the fire protection unit as well as of the ballistic block is preferably at least 3 mm, particularly preferably from 3 mm to 15 mm or from 4 mm to 15 mm, most particularly preferably from 4 mm to 8 mm. This means the thickness of each individual glass pane. The panes of the ballistic block and of the fire protection unit can have the same thickness or even different thicknesses.

The adhesion-promoting layers can be adhesive layers or films. Preferably used are films made of plastic. Preferably, the films are made of a plastic selected from the group consisting of polyvinyl butyral (PVB), ethylene vinyl acetate (EVA), polyurethane (PU), polypropylene (PP), polyacrylate, polyethylene (PE), polycarbonate (PC), polymethyl methacrylate (PMMA), polyvinyl chloride (PVC), polyacetate resin, casting resins, polyacrylates, fluorinated ethylene-propylene copolymers, polyvinyl fluoride, and/or ethylene-tetrafluoroethylene copolymers. In particular, polyvinyl butyral (PVB) or polyurethane (PU) is used. In the context of the invention, the adhesion-promoting layer is, in particular, not an intumescent layer, but instead serves only for the bonding of two panes.

The thickness of the adhesion-promoting layers is preferably from 0.3 mm to 5 mm, particularly preferably from 0.76 mm to 2.5 mm.

The above-cited Euro Standard EN 1063 distinguishes between bullet-resistant glazings with splintering and those without splintering. Bullet-resistant glazings with splintering do effectively stop a projectile; however, splinters can be released in the direction of the protected side, which can, in turn, cause a risk. The ballistic block according to the invention is preferably a ballistic block (bullet resistant unit) with splintering. These are easier to manufacture and, consequently, more economical than those without splintering. However, a possible risk from splinters is avoided with the glazing according to the invention in that the splinters are stopped by the fire protection unit arranged on the protected side relative to the ballistic block. This is a major advantage of the present invention.

In the transparent, shatterproof, bullet-resistant glazing, the surfaces of the at least one fire protection unit and of the at least one ballistic block are arranged parallel or substantially parallel to one another such that a hollow space is situated therebetween, which space is delimited outwardly by a preferably completely peripheral spacer. The spacer is arranged preferably completely peripherally in the edge region between the ballistic block and the fire protection unit. The ballistic block and the fire protection unit are thus joined to form an insulating glazing. The hollow space can be equipped with pressure equalization devices. The hollow space can be provided with negative pressure or filled with a protective gas, such as argon or krypton, in order to reduce heat transfer.

The space between the spacer and the side edges of the panes can be filled with a sealing compound, as is customary with insulating glazings, made, for example, of butyl rubber, polyurethane, polysulfide, and/or silicone.

In the context of the present invention, “substantially” means that the technical property in question can deviate from its exact value to an extent that the function or effect in question is not adversely affected.

With regard to the spacer, there are, in principle, no restrictions. It can be made from all usual materials. The spacer can, for example, be made of aluminum or stainless-steel. Alternatively, the spacer can be made of plastic and, in particular, implemented as a so-called “thermoplastic spacer” (TPS). The spacer can, for example, be made of polypropylene (PP), acrylonitrile butadiene styrene (ABS), acrylonitrile styrene acrylester (ASA), acrylonitrile butadiene styrene-polycarbonate (ABS/PC), styrene acrylonitrile (SAN), polyethylene terephthalate-polycarbonate (PET/PC), polybutylene terephthalate-polycarbonate (PBT/PC), or copolymers or derivatives or mixtures thereof. If the spacer is made of plastic, it can optionally be reinforced by glass fibers, for example, with a content from 5 to 40 wt.-%.

Preferably, the spacer is constructed from at least one bullet-resistant, hardly flammable or noncombustible material. Examples of suitable materials of this type are metals, in particular non-corroding metals such as stainless-steel, or flame retardant, high temperature resistant plastics that carbonize in the event of fire and form a solid carbon foam. The spacer can be constructed from a solid material or from hollow bodies. Preferably, stainless-steel is used as a hollow body.

Preferably, the spacer is adherently bonded to the fire protection unit and the ballistic block with adhesive layers or adhesive films.

The width of the spacer and, consequently, the distance between the opposing surfaces of the fire protection unit and of the ballistic block, is preferably from 8 mm to 28 mm.

The surface of the ballistic block facing away from the fire protection unit, which preferably forms an outer surface of the glazing, is, in the context of the invention referred to as the impact side. The surface of the fire protection unit facing away from the ballistic block, which likewise preferably forms an outer surface of the glazing, is referred to as the inner side. The fire protection unit faces away from the impact side of the ballistic block and faces the opposing inner side.

The transparent, shatterproof, bullet-resistant glazing with fire protection properties is preferably produced by
(a) constructing a laminate composite by precise, alternating superimpositioning of glass panes and films positioned therebetween and introducing in the bag method into an autoclave furnace and adherently bonding the glass panes and the films to form a composite safety glass, which forms the ballistic block,
(b) constructing a laminate composite by precise, alternating superimpositioning of glass panes and transparent, intumescent layers and introducing in the bag method into an autoclave furnace and adherently bonding the glass panes and the intumescent layers to form a composite, which forms the fire protection unit, and
(c) adherently bonding the ballistic block to the fire protection unit by a peripheral spacer such that a preferably closed hollow space is formed between the ballistic block and the fire protection unit.

The transparent, shatterproof, bullet-resistant glazing with fire protection properties can be used in many ways. Thus, it can be used as a movable or stationary functional and/or decorative single piece and as a built-in component in furniture, appliances, buildings, and means of transportation. In particular, it is used where there is a high risk of ballistic impact associated with a high risk of fire. For example, it is used as an architectural construction element (in particular as a component of a glass door or a stationary glazing) in buildings, such as museums, banks, airports, terminals, or railway stations, where large crowds develop and/or valuables, expensive goods, works of art, or hazardous materials are used or stored. However, it can also be used to protect occupants of means of transport, in particular of means of transport as are used by the military or by the police, such as motor vehicles, trucks, armored vehicles, tanks, watercraft, or aircraft

### BRIEF DESCRIPTION OF THE FIGURES

The invention is described in detail with reference to an exemplary embodiment and a comparative example according to the prior art. They depict in simplified, not-to-scale representation:

FIG. 1 a vertical longitudinal section through a detail of the transparent, shatterproof, bullet-resistant glazing with fire protection properties and

FIG. 2 a vertical longitudinal section through a detail of a transparent, non-shatterproof, bullet-resistant glazing with fire protection properties according to the prior art.

In the figures, the reference characters have the following meaning:
1 transparent, shatterproof, bullet-resistant glazing with fire protection properties
1a transparent, non-shatterproof, bullet-resistant glazing with fire protection properties
2 transparent fire protection unit
2.1 pane of the transparent fire protection unit 2
2.2 transparent, intumescent layer
3 ballistic block
3.1 pane of the ballistic block
3.2 transparent, adhesion-promoting layer
3.3 transparent, adhesion-promoting layer between the transparent fire protection unit 2 and the ballistic block 3
4 spacer
A impact side
B impact direction
H hollow space
I the inner side opposite impact side A
M monolithic glazing
S direction of splintering

### DETAILED DESCRIPTION OF THE FIGURES

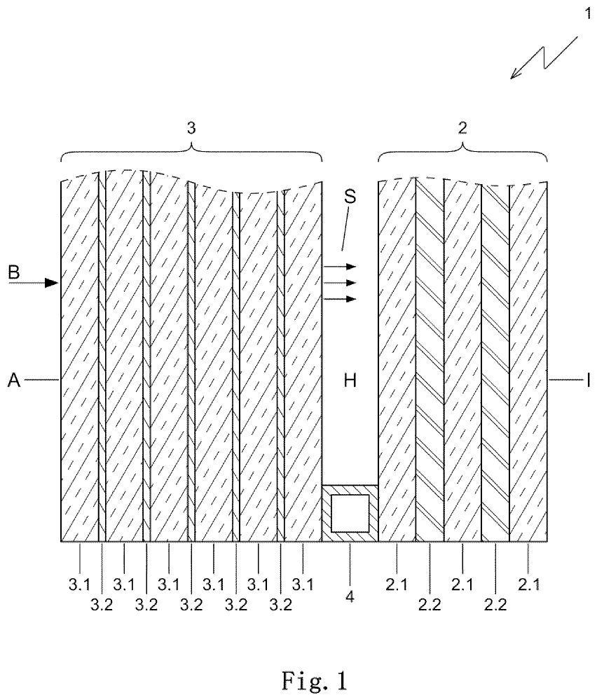

### FIG. 1

FIG. 1 depicts a vertical longitudinal section of a detail of an embodiment of the transparent, shatterproof, bullet-resistant glazing 1 with fire protection properties according to the invention. The glazing 1 according to the invention was fixed in a suitable, bullet-resistant steel frame (not shown).

The fire protection unit 2 was constructed from three 4-mm-thick glass panes 2.1 made of soda lime glass and two 3-mm-thick, transparent alkali silicate layers 2.2 positioned therebetween. The alkali silicate layers 2.2 were UV-protected. Examples of suitable UV stabilizers are known from the German patent application DE 10 2005 006 748 A1.

The ballistic block 3 was constructed from six 4-mm-thick glass panes 3.1 made of soda lime glass and five 0.76-mm-thick polyvinyl butyral-films (PVB).

Used as spacer 4 was a suitable peripheral frame made of a rectangular tube made of stainless steel. The rectangular tube 4 had a square cross-section with a side length of 6 mm and a wall thickness of 1 mm. The frame 4 was first glued using a glass-metal adhesive on the side of the ballistic block 3 facing away from the impact side A. Then, the fire protection unit 2 was likewise bonded to the frame 4 with a glass-metal adhesive on the side positioned opposite the inner side I such that a closed hollow space H resulted between the ballistic block 3 and the fire protection unit 2. The hollow space H could also be filled with argon in order to reduce the thermal transfer to the fire protection unit 2. Moreover, the hollow space H could be equipped with devices for pressure equalization.

The glazing according to the invention 1 had excellent bullet-resistant properties. When, with a bombardment B, a release of splinters S occurred, they were caught in the hollow space H of the stable fire protection unit 2 and, consequently, could no longer enter into the interior that was to be protected. In this manner, the bullet-resistant effect and the splinter safety of the glazing 1 was significantly improved. On the other hand, the ballistic block 3 contributed significantly to the fire protection by the fire protection unit 2. Thus, flames on the impact side A had to first overcome the ballistic block 3, after which they were effectively stopped by the fire protection unit 2.

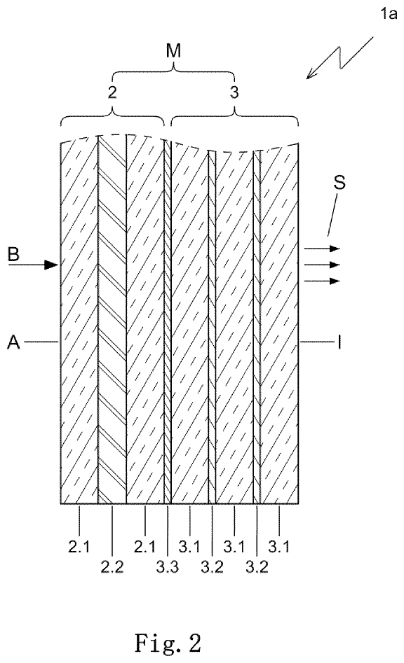

### FIG. 2

FIG. 2 depicts a vertical longitudinal section through a detail of a monolithic, transparent, non-shatterproof, bullet-resistant glazing 1a with fire protection properties according to the prior art.

The same materials and dimensions were used for the monolithic, transparent, non-shatterproof, bullet-resistant glazing 1a with fire protection properties as with the glazing 1 of FIG. 1.

The glazing 1a consisted of a fire protection unit 2 with two glass panes 2.1 made of soda lime glass that were bonded to one another via a transparent, intumescent layer. The fire protection unit 2 was arranged on the impact side A of the glazing 1a and adherently bonded to the ballistic block 3 via a PVB film 3.3. The ballistic block 3 was constructed from three glass panes 3.1 made of soda lime glass that were adherently bonded to one another via two PVB films.

With a bombardment B, the projectiles first struck the fire protection unit 2, which, however, offered no effective protection against projectile penetration. If the projectiles then, virtually unchecked, struck the ballistic block B, there was a great risk that outgoing splinters S penetrated into the interior and severely injured individuals situated there. Another substantial disadvantage of the monolithic glazing 1a was that it was difficult to manufacture and its production was associated with high reject rates.

1. A transparent, shatterproof, bullet-resistant glazing with fire protection properties, consisting of
a ballistic block constructed from at least two transparent panes adherently bonded to one another by at least one transparent, adhesion-promoting layer, wherein each pane has a thickness of at least 3 mm,
a fire protection unit constructed from at least two transparent panes adherently bonded by a transparent, intumescent layer, and
at least one spacer between the fire protection unit and the ballistic block, the surfaces of said fire protection unit and said ballistic block being arranged parallel or substantially parallel to one another such that a hollow space is situated therebetween.

2. The glazing according to claim 1, which is fitted into a peripheral, bullet-proof frame.

3. The glazing according to claim 1, wherein the adhesion-promoting layers of the ballistic block are made of films of a plastic, selected from the group consisting of polyvinyl butyral, ethylene vinyl acetate, and polyurethane.

4. The glazing according to claim 1, wherein the ballistic block is a unit with splintering per standard EN1063.

5. The glazing according to claim 1, wherein the at least one transparent, intumescent layer of the transparent fire protection unit is constructed from alkali silicates and/or with salt-filled, aqueous acrylic polymers.

6. The glazing according to claim 5, wherein the at least one transparent, intumescent layer is UV-protected.

7. The glazing according to claim 1, wherein the ballistic block is constructed from two to eight panes.

8. The glazing according to claim 1, wherein the transparent panes are glass panes.

9. The glazing according to claim 8, wherein the transparent panes are constructed from soda lime glass.

10. The glazing according to claim 1, wherein the ballistic block has at least four panes and the fire protection unit has at least three panes.

11. The glazing according to claim 1, wherein the spacer is arranged completely peripherally in an edge region between the ballistic block and the fire protection unit.

12. The glazing according to claim 1, wherein the spacer is constructed from at least one bullet-resistant, hardly flammable or noncombustible material.

13. A method for producing a transparent, shatterproof, bullet-resistant glazing with fire protection properties according to claim 1 by
(a) constructing a laminate composite by precise, alternating superimpositioning of glass panes and films positioned therebetween and introducing in the bag method into an autoclave furnace and adherently bonding the glass panes and the films to form a composite safety glass, which forms the ballistic block,
(b) constructing a laminate composite by precise, alternating superimpositioning of glass panes and transparent, intumescent layers and introducing in the bag method into an autoclave furnace and adherently bonding the glass panes and the intumescent layers to form a composite, which forms the fire protection unit, and
(c) adherently bonding the ballistic block to the fire protection unit by a peripheral spacer such that a hollow space is formed between the ballistic block and the fire protection unit.

14. A method comprising utilizing a transparent, shatterproof, bullet-resistant glazing with fire protection properties according to claim 1 as an architectural construction element in a buildings.

15. The method according to claim 14, wherein the ballistic block faces an attack side and the fire protection unit faces a protected side.

16. The method according to claim 14, wherein the building is a museum, a bank, an airport, a terminal, or a railway station.
